(19) United States
(12) Patent Application Publication
(10) Pub. No.: US 2025/0389646 A1
(43) Pub. Date: Dec. 25, 2025

(54) PORTABLE SPECTROMETER

(71) Applicant: TRINAMIX GMBH, Ludwigshafen Am Rhein (DE)

(72) Inventor: Michael HANKE, Ludwigshafen am Rhein (DE)

(21) Appl. No.: 18/881,329

(22) PCT Filed: Jul. 25, 2023
(86) PCT No.: PCT/EP23/70558

§ 371 Date: Jan. 6, 2025

(30) Foreign Application Priority Data
Jul. 26, 2022 (EP) 22186971.2

(51) Int. Cl. G01N 21/31

(52) U.S. Cl. CPC G01N 21/31; G01N 2201/0221

(57) ABSTRACT

Disclosed herein is a portable spectrometer for performing at least one optical measurement on at least one measurement object. The portable spectrometer includes:

at least one optical element configured for separating incident optical radiation provided by the measurement object into a spectrum of constituent wavelength components;

at least one photosensor including at least one photosensitive region configured for receiving the optical radiation from the optical element;

at least one movement sensor configured for generating at least one movement sensor signal dependent on a movement of at least one of the portable spectrometer and the measurement object; and

at least one evaluation device configured for determining at least one item of measurement quality information on the optical measurement by using the movement sensor signal. Also disclosed herein is a method for performing at least one optical measurement on at least one measurement object.

### TECHNICAL FIELD

The invention relates to a portable spectrometer and a method for performing at least one optical measurement on at least one measurement object. Generally, such devices and methods may be employed for various applications. They may specifically be used for investigation or monitoring purposes, specifically in the infrared (IR) spectral region, more specifically in the near-infrared (NIR) spectral region. As an example, they may be used for analysis of a chemical composition of a measurement object. However, further kinds of applications may also be possible.

### BACKGROUND ART

Spectroscopy and specifically infrared spectroscopy allow for an optical analysis of the chemical composition of a measurement object. In many cases, however, the composition differs spatially over the measurement object, for example for grains, forages or silages. To obtain a representative composition of the measurement object, the measurement object may need be to be measured in different locations.

For stationary devices, like laboratory spectrometers, sample holders are available which hold a larger sample and move it passed the measurement head, for example by rotation. For mobile devices, such additional equipment is typically undesirable as it typically adds space and weight and needs extra power supply. Therefore, portable spectrometers often are moved along the measurement object by hand, while several measurements may be recorded at different places, thereby obtaining, as an example, averaged measurements.

US 2017/0292908 A1 discloses a spectrometer system to determine one or more spectra of an object. The one or more spectra may be associated with one or more attributes of the object that are relevant to the user. While the spectrometer system can take many forms, in many instances the system comprises a spectrometer and a processing device in communication with the spectrometer and with a remote server, wherein the spectrometer is physically integrated with an apparatus. The apparatus may have a function different than that of the spectrometer, such as a consumer appliance or device.

However, depending on the user, different degrees of accuracy may be obtained. For example, if the spectrometer is moved too slowly or not at all, the measurement accuracy may decrease significantly as the spectrum may not be representative for the entirety of the inhomogeneous measurement object.

### PROBLEM TO BE SOLVED

It is therefore desirable to provide a portable spectrometer and a method for performing at least one optical measurement on at least one measurement object which at least substantially avoid the disadvantages of known devices and methods of this type. Specifically, it is desirable to provide a portable spectrometer and a method for performing at least one optical measurement on at least one measurement object which facilitate increasing the accuracy and reliability of optical measurements, specifically by obtaining a sufficiently representative spectrum of an entire measurement object, specifically for use by non-expert users.

### SUMMARY

This problem is addressed by a portable spectrometer and a method for performing at least one optical measurement on at least one measurement object with the features of the independent claims. Advantageous embodiments which might be realized in an isolated fashion or in any arbitrary combinations are listed in the dependent claims as well as throughout the specification.

In a first aspect of the present invention, a portable spectrometer for performing at least one optical measurement on at least one measurement object is disclosed. The term “spectrometer” as used herein is a broad term and is to be given its ordinary and customary meaning to a person of ordinary skill in the art and is not to be limited to a special or customized meaning. The term specifically may refer, without limitation, to device or system which is configured for determining spectral information, such as information on at least one spectrum of at least one measurement object, by recording at least one measured value for at least one signal intensity related to at least one corresponding signal wavelength of optical radiation provided by the measurement object and by evaluating at least one measurement signal which relates to the signal intensity.

The term “spectrum” including any grammatical variation thereof as used herein is a broad term and is to be given its ordinary and customary meaning to a person of ordinary skill in the art and is not to be limited to a special or customized meaning. The term specifically may refer, without limitation, to a partition of optical radiation, wherein the spectrum is constituted by an optical signal defined by at least one signal wavelength and at least one corresponding signal intensity, e.g. as a function of the signal wavelength. In particular, the spectrum may comprise spectral information related to at least one measurement object, such as a type and composition of at least one material forming the at least one measurement object, which can be determined by recording at least one spectrum related to the at least one measurement object.

The term “portable spectrometer” as used herein is a broad term and is to be given its ordinary and customary meaning to a person of ordinary skill in the art and is not to be limited to a special or customized meaning. The term specifically may refer, without limitation, to a spectrometer configured for being moved, specifically carried, by at least one user, specifically by only one user. More specifically, the portable spectrometer may be configured, specifically by at least one of a size of the portable spectrometer and a weight of the portable spectrometer, for being carried by only one user in his or her hand. The portable spectrometer may be operable or controllable by only one user. The portable spectrometer may be a handheld spectrometer. The portable spectrometer may be a mobile spectrometer. The portable spectrometer may be a miniaturized spectrometer. As an example, a volume of the portable spectrometer may not exceed 0.001 m³ and/or a weight of the portable spectrometer may not exceed 5 kg, specifically a weight of the portable spectrometer may not exceed 1 kg. The portable spectrometer may be or may be a part of a mobile device or a wearable device. As an example, the portable spectrometer may be a part of a smartphone, a tablet or a smartwatch. Other options may be feasible. The portable spectrometer may specifically facilitate a consumer friendly application, specifically for non-expert users.

The term “optical measurement” as used herein is a broad term and is to be given its ordinary and customary meaning to a person of ordinary skill in the art and is not to be limited to a special or customized meaning. The term specifically may refer, without limitation, to a measurement using optical radiation, specifically for measuring or investigating at least one measurement object. Specifically, the optical measurement may comprise detecting and/or analyzing optical radiation provided by the measurement object, such as optical radiation emitted and/or reflected and/or transmitted by the measurement object. The optical measurement may yield information on at least one optical property of the measurement object, wherein the optical property may be indicative of at least one further physical or chemical property of the measurement object. Specifically, the optical measurement may be or comprise at least one spectral measurement. As an example, the optical measurement may yield a spectral absorbance of the measurement object which may be indicative of a chemical composition of the measurement object. Additionally or alternatively to a spectral measurement, the optical measurement may also comprise other optical measurements, e.g. optical position or speed measurements. Other options may be feasible.

The term “optical radiation” as used herein is a broad term and is to be given its ordinary and customary meaning to a person of ordinary skill in the art and is not to be limited to a special or customized meaning. The term specifically may refer, without limitation, to electromagnetic radiation, specifically within at least one of the visible, the ultraviolet or the infrared spectral range. The term “ultraviolet”, generally, refers to electromagnetic radiation having a wavelength of 1 nm to 380 nm, preferably of 100 nm to 380 nm. Further, the term “visible”, generally, refers to a wavelength of 380 nm to 760 nm. Further, the term “infrared”, abbreviated by “IR”, generally refers to a wavelength of 760 nm to 1000 μm, wherein the wavelength of 760 nm to 3 μm is, usually, denominated as “near infrared”, abbreviated by “NIR”. Preferably, the optical radiation which is used for typical purposes of the present invention is IR radiation, more preferred, NIR radiation, especially of a wavelength of 760 nm to 3 μm, preferably of 1 μm to 3 μm. As indicated, the optical radiation may be provided by at least one measurement object, wherein the providing may comprise at least one of a reflecting, transmitting and emitting. As will be outlined in further detail below, before interacting with the measurement object, the optical radiation may be emitted by at least one radiation source. After interaction with the measurement object, the optical radiation may impinge the spectrometer, specifically a photosensor of the spectrometer, more specifically a photosensitive region of the photosensor. The term “optical radiation” may also be referred to as “illumination” or as “light” herein.

The term “measurement object” as used herein is a broad term and is to be given its ordinary and customary meaning to a person of ordinary skill in the art and is not to be limited to a special or customized meaning. The term specifically may refer, without limitation, to an arbitrary body, chosen from a living body and a non-living body. The measurement object may specifically comprise at least one material which is subject to an investigation by the spectrometer. The measurement object may specifically be an object which is to be measured, e.g. for which a spectrum is to be recorded, wherein the object may have arbitrary properties, e.g. arbitrary optical properties or an arbitrary shape. The measurement object may comprise at least one solid or fluid sample. Other options may be feasible.

The portable spectrometer comprises:
at least one optical element configured for separating incident optical radiation provided by the measurement object into a spectrum of constituent wavelength components;
at least one photosensor comprising at least one photosensitive region configured for receiving the optical radiation from the optical element, wherein the photosensor is configured for generating at least one photosensor signal dependent on an illumination of the photosensitive region by the optical radiation;
at least one movement sensor configured for generating at least one movement sensor signal dependent on a movement of at least one of the portable spectrometer and the measurement object; and
at least one evaluation device configured for determining at least one item of measurement quality information on the optical measurement by using the movement sensor signal, wherein the evaluation device is further configured for determining at least one item of spectral measurement information on the measurement object by using the photosensor signal.

The portable spectrometer comprises at least one optical element. The optical element is configured for separating incident optical radiation provided by the measurement object into a spectrum of constituent wavelength components. The term “optical element” as used herein is a broad term and is to be given its ordinary and customary meaning to a person of ordinary skill in the art and is not to be limited to a special or customized meaning. The term specifically may refer, without limitation, to an arbitrary element configured for influencing optical radiation. Specifically, the optical element may be configured for at least one of at least partially dispersing the optical radiation, at least partially filtering the optical radiation, at least partially reflecting the optical radiation, e.g. diffusely or directly, at least partially deflecting the optical radiation, at least partially transmitting the optical radiation and at least partially absorbing the optical radiation. The optical element may comprise at least one of a prism, a grating and a beam splitter. The optical element may specifically be configured for being used in mobile applications, for example for being used in handheld spectrometer devices and/or in spectrometer devices comprised by electronic communication devices, such as a smartphone or a tablet. As another example, the optical element may comprise at least one optical filter element. The optical filter element may be configured for filtering the optical radiation or more specifically at least one selected spectral range of the optical radiation. The optical filter element may specifically be positioned in a light path before the photosensor. As an example, the portable spectrometer may comprise a plurality of a photosensors, e.g. arranged as pixels in an array or in a matrix, and a plurality of optical filter elements, wherein an optical filter element may be positioned in a beam path before each photosensor. A plurality of other options may be feasible and are generally known to the skilled person.

The portable spectrometer comprises at least one photosensor. The photosensor comprises at least one photosensitive region. The photosensitive region is configured for receiving the optical radiation from the optical element. The photosensor is configured for generating at least one photosensor signal dependent on an illumination of the photosensitive region by the optical radiation. The term “sensor” as used herein is a broad term and is to be given its ordinary and customary meaning to a person of ordinary skill in the art and is not to be limited to a special or customized meaning. The term specifically may refer, without limitation, to a device configured for detecting at least one condition or for measuring at least one measurement variable. The sensor may be capable of generating at least one signal, such as a measurement signal, which is a qualitative or quantitative indication of the measurement variable and/or measurement property, e.g. of an illumination of the sensor or a part of the sensor. The signal may be or comprise an electrical signal, such as a current, specifically a photocurrent. The term “photosensor” as used herein is a broad term and is to be given its ordinary and customary meaning to a person of ordinary skill in the art and is not to be limited to a special or customized meaning. The term specifically may refer, without limitation, to a sensor or a detector configured for detecting or measuring optical radiation, such as for detecting an illumination and/or a light spot generated by at least one light beam, e.g. by using the photoelectric effect. The photodetector may comprise at least one substrate. As an example, a single photosensor may be a substrate with at least one single photosensitive region, which generates a physical response, e.g. an electronic response, to the illumination for a given wavelength range.

The term “photosensitive region” as used herein is a broad term and is to be given its ordinary and customary meaning to a person of ordinary skill in the art and is not to be limited to a special or customized meaning. The term specifically may refer, without limitation, to a unit of the photosensor, specifically to a spatial area or volume being part of the photosensor, configured for being illuminated, or in other words for receiving optical radiation, and for generating at least one signal, such as an electronic signal, in response to the illumination. The photosensitive region may be located on a surface of the photosensor. The photosensitive region may specifically be a single, closed, uniform photosensitive region. However, other options may also be feasible.

The term “signal” as used herein is a broad term and is to be given its ordinary and customary meaning to a person of ordinary skill in the art and is not to be limited to a special or customized meaning. The term specifically may refer, without limitation, to an observable change in at least one physical quantity. The signal may be or comprise a sign or a function conveying information about the at least one physical quantity. The signal may specifically be or comprise at least one of an electronic signal, an optical signal or an optoelectronic signal. The signal may be a variable signal, specifically over time. The signal may be an analog signal. The signal may be or comprise at least one of a variable voltage, a variable current, a variable charge, a variable resistance or, generally, a variable electromagnetic wave. The variable electromagnetic wave may comprise at least one of a variable amplitude, a variable frequency or a variable phase. The signal may be a digital signal. The signal may comprise at least one count, as e.g. generated by an analog-to-digital converter. The signal may specifically be generated by at least one sensor, more specifically in response to at least one measurement. Other options may be feasible.

Consequently, the term “photosensor signal” as used herein is a broad term and is to be given its ordinary and customary meaning to a person of ordinary skill in the art and is not to be limited to a special or customized meaning. The term specifically may refer, without limitation, to a signal generated by a photosensor, specifically in response to at least one optical measurement. The portable spectrometer may be configured, e.g. by using at least one of a wire and a trace, for transmitting the photosensor signal from the photosensor to the evaluation device, specifically for further processing and/or evaluation, e.g. for evaluating physical and/or chemical properties of the measurement object.

Analogously, the term “movement sensor signal” as used herein is a broad term and is to be given its ordinary and customary meaning to a person of ordinary skill in the art and is not to be limited to a special or customized meaning. The term specifically may refer, without limitation, to a signal generated by a movement sensor, specifically in response to at least one measurement of a movement of at least one object, such as the portable spectrometer and/or the measurement object. The portable spectrometer may be configured, e.g. in a wire-bound fashion or wirelessly, such as by using at least one of a wire and a trace, for transmitting the movement sensor signal from the movement sensor to the evaluation device, specifically for further processing and/or evaluation, e.g. for evaluating a speed and/or a position of the portable spectrometer and/or the measurement object.

The portable spectrometer comprises at least one movement sensor. The movement sensor is configured for generating at least one movement sensor signal dependent on a movement of at least one of the portable spectrometer and the measurement object. The term “movement” as used herein is a broad term and is to be given its ordinary and customary meaning to a person of ordinary skill in the art and is not to be limited to a special or customized meaning. The term specifically may refer, without limitation, to a change in position over time, such as a change in the position of an object, e.g. the portable spectrometer and/or the measurement object, over time. The movement may comprise a change in the position of the center of mass of the portable spectrometer over time. The movement may comprise a change in the position of an arbitrary point of the portable spectrometer, such as an edge of the portable spectrometer, for example a rotation of the portable spectrometer. The movement may specifically be a change in a relative position of the portable spectrometer with respect to the measurement object. Thus, alternatively or additionally, the movement may comprise a change in the position of the center of mass of the measurement object over time. The movement may comprise a change position of an arbitrary point of the measurement object, such as an edge of the measurement object, e.g. during a rotation of the measurement object. The movement may comprise at least one of a translation of the object, a rotation of the object and a deformation of the object, wherein the object may comprise at least one of the portable spectrometer and the measurement object.

The term “movement sensor” as used herein is a broad term and is to be given its ordinary and customary meaning to a person of ordinary skill in the art and is not to be limited to a special or customized meaning. The term specifically may refer, without limitation, to a detector configured for detecting or measuring a movement of at least one object. The movement sensor may be configured for quantitatively detecting the movement. In other words, the movement sensor may be configured for detecting whether there is a movement or not and/or for quantifying the movement. Specifically, the movement sensor may be configured for qualitatively detecting the movement. The movement sensor may be configured for measuring at least one of a speed and an acceleration of the movement or of the moving object, such as of the portable spectrometer and/or of the measurement object, as will also be outlined in further detail below. The movement sensor may comprise at least one of an acceleration sensor, a speed gauge, a position sensor, a gyroscope and an optical sensor, specifically an optical speed sensor. The optical speed sensor may e.g. be configured for measuring a speed of the measurement object, e.g. in the case that the measurement object is moved relative to the spectrometer. As the skilled person will know, acceleration, speed and position are physically directly connected to each other and can thus be derived from each other, such as by integration over time or by time derivation, e.g. by using the evaluation device. As outlined above, the movement sensor is comprised by the portable spectrometer device, such as by arranging the movement sensor in a housing of the portable spectrometer, for example by being included in the portable spectrometer's electronics in the housing of the portable spectrometer itself.

The portable spectrometer comprises at least one evaluation device. The evaluation device is configured for determining at least one item of measurement quality information on the optical measurement by using the movement sensor signal. The evaluation device is further configured for determining at least one item of spectral measurement information on the measurement object by using the photosensor signal. The term “evaluation device” as used herein is a broad term and is to be given its ordinary and customary meaning to a person of ordinary skill in the art and is not to be limited to a special or customized meaning. The term specifically may refer, without limitation, to a device or system configured for analyzing or interpreting data, specifically for determining at least one item of qualitative or quantitative information. The information may specifically be obtained by evaluating at least one signal, such as the photosensor signal and/or the movement sensor signal. The evaluation device may be or may comprise at least one of an integrated circuit, in particular an application-specific integrated circuit (ASIC), or a data processing device, in particular at least one of a digital signal processor (DSP), a field programmable gate array (FPGA), a microcontroller, a microcomputer, a computer, or an electronic communication device, specifically a smartphone or a tablet. Further components may be feasible, in particular at least one preprocessing device or data acquisition device. The evaluation device may comprise at least one interface, in particular at least one of a wireless interface or a wire-bound interface. The evaluation device may be designed to carry out at least one measurement cycle in which a plurality of measurement signals may be picked up. The evaluation device may be comprised by the portable spectrometer by having at least one signal connection path, either wire-bound or wireless, for exchanging signals, specifically for exchanging the movement sensor signal, between the movement sensor and the evaluation device. For example, the evaluation device may be or may be comprised by an electronic communication device, such as a smartphone or a tablet, wherein the other components of the portable spectrometer may also be comprised by the electronic communication device and wherein at least one signal connection path may be provided between the evaluation device and the movement sensor. Alternatively or additionally, the evaluation device may be arranged remote from the other components of the portable spectrometer device, for example by being arranged in a cloud computer network. At least one signal connection path may be provided between the remote evaluation device and the movement sensor, such as a high-bandwidth signal connection path, for example using a high-bandwidth signal connection path based on the 5G standard.

Information as determined by the evaluation device may, in particular, be provided to at least one of a further apparatus, or to a user, preferably in at least one of an electronic, visual, acoustic, or tactile fashion. The information may be stored in at least one data storage device, specifically in an internal data storage device as comprised by the portable spectrometer, in particular by the at least one evaluation device, or in an separate storage device to which the information may be transmitted via the at least one interface. The separate storage device may be comprised by the electronic communication device. The storage device may in particular be configured for storing at least one electronic table, such as at least one look-up table.

The evaluation device may be configured to perform at least one computer program, in particular at least one computer program performing or supporting the step of generating the at information. By way of example, one or more algorithms may be implemented which, by using the at least one measurement signal as at least one input variable, may perform a transformation into a piece of information. For this purpose, the evaluation device may comprise at least one data processing device, in particular at least one of an electronic or an optical data processing device, which can be designed to generate the information by evaluating at least one signal. The evaluation device may be designed to use the signal as at least one input variable and to generate the information by processing the input variable. The processing can be performed in a consecutive, a parallel, or a combined manner. The evaluation device may use an arbitrary process for generating the information, in particular by calculation and/or using at least one stored and/or known relationship.

The term “item of measurement quality information” as used herein is a broad term and is to be given its ordinary and customary meaning to a person of ordinary skill in the art and is not to be limited to a special or customized meaning. The term specifically may refer, without limitation, to knowledge or evidence providing a qualitative and/or quantitative description relating to at least one of a quality, an accuracy, a precision and a reliability of a measurement, specifically of the optical measurement. The item of measurement quality information may comprise at least one indication of the quality of the optical measurement, such as an expected accuracy of the optical measurement. The item of measurement quality information may comprise, qualify or quantify, as an example, at least one factor, specifically at least one physical quantity, affecting a quality of the optical measurement, such as a position and/or a speed of the portable spectrometer and/or the measurement object. The quality of the optical measurement may generally depend on a several aspects. As already indicated, specifically when analyzing an inhomogeneous measurement object, the inhomogeneous measurement object may typically need to be measured at different positions in order to obtain a representative spectrum relating to the entire measurement object. Thus, knowledge relating to a quality of the optical measurement may for instance be knowledge about a position of the portable spectrometer relative to the measurement object or also a speed of portable spectrometer relative to the measurement object as the skilled person will understand. Further options may be feasible. Several specific examples will be outlined in further detail below.

The term “item of spectral measurement information” as used herein is a broad term and is to be given its ordinary and customary meaning to a person of ordinary skill in the art and is not to be limited to a special or customized meaning. The term specifically may refer, without limitation, to knowledge or evidence providing a qualitative and/or quantitative description relating to the optical properties of the measurement object, specifically to spectral properties of the measurement object, or to physical and/or chemical properties of the measurement object derived thereof. The item of spectral measurement information may comprise at least one of a physical property of the measurement object or a chemical composition of the at least one measurement object. The physical property may specifically comprise an optical property such at least one absorbance of the measurement object and/or at least one emissivity of the measurement object.

The chemical composition may specifically refer to qualitative and/or quantitative information on at least one material the measurement object comprises.

The movement sensor signal may be dependent on at least one of: an absolute movement of the portable spectrometer, specifically a speed of the portable spectrometer; an absolute movement of the measurement object, specifically a speed of the measurement object; a relative movement of the portable spectrometer with respect to the measurement object or vice versa, specifically a relative speed. The term “absolute movement” as used herein is a broad term and is to be given its ordinary and customary meaning to a person of ordinary skill in the art and is not to be limited to a special or customized meaning. The term specifically may refer, without limitation, to a movement observed or measured in an inertial frame of reference, i.e. a frame of reference which is not undergoing acceleration, at least in good approximation, e.g. a laboratory room while neglecting gravity. As an example, an absolute movement of the portable spectrometer may be a movement of the portable spectrometer performed by a user experiencing no acceleration, at least in good approximation, such as a user standing in a room or also outside, e.g. on a street, and holding the portable spectrometer in his or her hand. As another example, an absolute movement of the measurement object may be a movement of the measurement object performed by using a laboratory stage, e.g. a linear translation stage.

The term “speed” as used herein is a broad term and is to be given its ordinary and customary meaning to a person of ordinary skill in the art and is not to be limited to a special or customized meaning. The term specifically may refer, without limitation, to a rate of change in position over time, such as during a translation or a rotation of an object, specifically of at least one of the portable spectrometer and the measurement object. The speed may comprise at least one of a velocity and an angular velocity. The term “speed” may typically, if not indicated otherwise, refer to an absolute speed, i.e. a rate of change in position with respect to an inertial frame of reference over time. Thus, the term “speed” may specifically refer to a speed perceived by a, at least in good approximation, non-accelerated user, such as a user standing in a room.

The term “relative movement” as used herein is a broad term and is to be given its ordinary and customary meaning to a person of ordinary skill in the art and is not to be limited to a special or customized meaning. The term specifically may refer, without limitation, to a movement of an object observed or measured relative to a further object, wherein the further object may optionally also be moving. The relative movement may be refer to a superposition of the absolute movement of the object and the absolute movement of the further object. As an example, the measurement object may be moved in one direction and the portable spectrometer may be moved in the same direction with the same speed, such that there may be no relative movement of the portable spectrometer with respect to the measurement object.

The term “relative speed” as used herein is a broad term and is to be given its ordinary and customary meaning to a person of ordinary skill in the art and is not to be limited to a special or customized meaning. The term specifically may refer, without limitation, to a speed of an object observed or measured relative to a further object, wherein the further object may optionally also be moving with a further speed. The relative speed may be a superposition, specifically a vector addition, of the speed of the object and the further speed of the further object. As an example, the measurement object may be moved in one direction and the portable spectrometer may be moved in the same direction with the same speed, such that there may be no relative speed. The skilled person will be well aware of basic kinematic principles and further possible scenarios.

The item of measurement quality information on the optical measurement may comprise information indicating whether at least one predetermined measurement condition for an accurate optical measurement on the measurement object is fulfilled, specifically at least one measurement condition regarding at least one of: the movement of at least one of the portable spectrometer and the measurement object; a position of at least one of the portable spectrometer and the measurement object. The term “predetermined measurement condition” as used herein is a broad term and is to be given its ordinary and customary meaning to a person of ordinary skill in the art and is not to be limited to a special or customized meaning. The term specifically may refer, without limitation, to a criterion regarding at least one measurement parameter as specified before the optical measurement or at a beginning of the optical measurement. As an example, the measurement object may be of a certain type which typically has a high inhomogeneity and thus requires a higher moving speed of the portable spectrometer for an accurate optical measurement as already indicated above. Thus, the predetermined measurement condition may comprise a minimum speed of the portable spectrometer, which may be predetermined by specifying the type of the measurement object, as will also be described below in further detail.

The term “accuracy” including any grammatical variation thereof as used herein is a broad term and is to be given its ordinary and customary meaning to a person of ordinary skill in the art and is not to be limited to a special or customized meaning. The term specifically may refer, without limitation, to an indication of at least one of a precision and a reliability, specifically of the optical measurement. Additionally or alternatively, the accuracy may comprise an indication of at least one of a measurement uncertainty and a measurement error, specifically of the optical measurement. As an example, the accuracy may be determined by performing a series of measurements and tracking fluctuations in measurement results. The accuracy may comprise an indication of a reproducibility of the measurement results. As a further example, the accuracy may be determined by comparing the measurement results with theoretically calculated data, e.g. simulated data. The term “accurate optical measurement” as used herein is a broad term and is to be given its ordinary and customary meaning to a person of ordinary skill in the art and is not to be limited to a special or customized meaning. The term specifically may refer, without limitation, to an optical measurement fulfilling at least one minimum requirement for at least one of precision, reliability and reproducibility. The minimum requirement, e.g. the minimum requirement for precision, such as a precision of at least 95% for instance, may be predetermined, e.g. by a user or by a manufacturer of the portable spectrometer or by a technical standard. An accurate optical measurement may be at least one of a sufficiently precise optical measurement, a sufficiently reliable optical measurement and a sufficiently reproducible optical measurement. An accurate optical measurement may be an optical measurement yielding a strong signal, such as a high signal intensity of a measurement signal. An accurate optical measurement may be an optical measurement yielding a spectrum matching, at least in good approximation, a reference spectrum, such as a reference spectrum of a further measurement object of the same type. As the skilled person will understand, typically, a perfect precision, reliability and/or reproducibility is practically impossible for real experiments. However, a high precision, reliability and/or reproducibility, such as a precision of 95% for instance, may already be sufficient for many applications.

The item of measurement quality information on the optical measurement may comprise an expected accuracy of the optical measurement. The expected accuracy may be derived by using the movement sensor signal. The term “expected accuracy” as used herein is a broad term and is to be given its ordinary and customary meaning to a person of ordinary skill in the art and is not to be limited to a special or customized meaning. The term specifically may refer, without limitation, to an accuracy determined or at least estimated by using at least one measurement parameter, specifically a measurement parameter of the optical measurement relating to a movement of at least one of the portable spectrometer and the measurement object, such as a speed of at least one of the portable spectrometer and the measurement object. As already indicated, the lower the speed of the portable spectrometer and/or the measurement object may be, the lower the accuracy of the optical measurement may be. Thus, the expected accuracy may be determined by using the speed and/or the position of the portable spectrometer and/or the measurement object. The expected accuracy may be determined by using at least one of a physical formula, a mathematical function, an algorithm, a simulation, a model and a look-up table. Other options may be feasible.

The expected accuracy may be determined by using the movement sensor signal and at least one threshold, wherein the threshold is determined prior to in-field use of the portable spectrometer, such as in a laboratory under controlled conditions with varying movements and/or accelerations of the portable spectrometer. For example, the measurement object may comprise whole grains, wherein each grain may have a slightly different chemical composition, such as in terms of moisture, protein, starch, fat, sugar or the like. Hence by only moving over a limited amount of grains, or not moving the measurement object at all, the photosensor signal and, thus, the item of spectral measurement information, for example a chemometric concentration prediction, may not be representative for the entire measurement object. For example, a locally higher concentration of e.g. protein may occur which may be not representative for the entire measurement object. Therefore, a measurement that is limited to a specific spot may be doomed not to be representative. An accuracy may be determined by repeating the measurement multiple times with movement of the measurement object, wherein a high accuracy may be assigned to measurements having a representative portion of the measurement object moved over the spectrometer, wherein a high accuracy may imply a low scatter of the chemometric concentration prediction. This would then define a minimum amount of movement necessary for assigning a high accuracy of the measurement, wherein the minimum amount of movement may define the threshold to be used for determining the expected accuracy. The respective threshold may be determined prior to in-field measurements, such as in a factory calibration in a laboratory for a specific application and then referenced to any subsequent in-field measurement. Hence, the accuracy may not need to be assessed every time a measurement is performed but it can be assumed to be given once a certain speed is exceeded. Specifically, the threshold may be determined in the laboratory for a representative sample and a minimum required speed and/or distance per integration time may be stored to be accessed by the evaluation device.

The evaluation device may be configured for automatically using the item of measurement quality information on the optical measurement as a trigger for determining the item of spectral measurement information on the measurement object, specifically by automatically triggering the determining of the item of spectral measurement information on the measurement object if the item of measurement quality information indicates that at least one predetermined measurement condition for an accurate optical measurement on the measurement object is fulfilled. The term “automatically” including any grammatical variation thereof as used herein is a broad term and is to be given its ordinary and customary meaning to a person of ordinary skill in the art and is not to be limited to a special or customized meaning. The term specifically may refer, without limitation, to a process which is performed without the necessity of human interaction, specifically completely by means of at least one device and/or system, specifically the portable spectrometer, more specifically the evaluation device, in particular without manual action and/or interaction with a user. Specifically, the decision on determining the item of spectral measurement information on the measurement object or not, depending on the determined item of measurement quality information on the optical measurement, may be performed by the portable spectrometer, specifically by the evaluation device, in particular without performing a user query or any other user interaction.

The term “trigger” including any grammatical variation thereof as used herein is a broad term and is to be given its ordinary and customary meaning to a person of ordinary skill in the art and is not to be limited to a special or customized meaning. The term specifically may refer, without limitation, to an enabler of at least one event or to a release for the event, specifically to an enabler of determining the item of spectral measurement information on the measurement object in the optical measurement or to a release for determining the item of spectral measurement information on the measurement object in the optical measurement. The trigger may be or may comprise at least one decision-maker or a decision-making criterion, wherein a decision may for instance be made according to at least one predetermined classification, e.g. according to at least one range of at least one physical quantity, e.g. a range above or below a predetermined threshold. The trigger may specifically make or induce a decision whether to determine the item of spectral measurement information on the measurement object or not, specifically depending on the determined item of measurement quality information on the optical measurement. The trigger may be configured for at least partially controlling the optical measurement, specifically data collection during the optical measurement. Specifically, the trigger may be configured for controlling when the item of spectral measurement information on the measurement object is determined during the optical measurement. At least in some cases, determining the item of spectral measurement information on the measurement object during the optical measurement may yield untrustworthy results and may thus be misleading for a user, e.g. because only a small part of an inhomogeneous measurement object was observed as already indicated. The trigger may be configured for preventing collection of unnecessary and/or misleading measurement data. Several examples will be outlined below and further options may also be feasible. The trigger may be technically implemented by using at least one electronic circuit configured for generating at least one of a switching operation and a trigger signal, e.g. a binary digital signal, upon at least one decision-making process, e.g. a comparison. Thus, the electronic circuit may comprise at least one of a switch, specifically a transistor, and an operation amplifier, specifically a comparator, e.g. a Schmitt-trigger. Other options may be feasible.

The item of measurement quality information on the optical measurement may comprise at least one of a speed of the portable spectrometer, a speed of the measurement object and a relative speed of the portable spectrometer with respect to the measurement object. The item of measurement quality information on the optical measurement may comprise at least one entity, e.g. a physical quantity, derived from the speed and/or at least one item of information relating to the speed, e.g. a comparison to at least one further entity. The item of measurement quality information on the optical measurement may indicate whether the speed exceeds a predetermined threshold. The term “predetermined threshold” as used herein is a broad term and is to be given its ordinary and customary meaning to a person of ordinary skill in the art and is not to be limited to a special or customized meaning. The term specifically may refer, without limitation, to a predetermined limit, such as a predetermined minimum value or a predetermined maximum value of a physical quantity, triggering at least one event when exceeded. The predetermined threshold may specifically depend on a type of the measurement object. Specifically, as will also be outlined below, the predetermined threshold may be or may comprise a minimum value for at least one of a speed of the portable spectrometer, a speed of the measurement object and a relative speed of the portable spectrometer with respect to the measurement object. As already indicated, the more inhomogeneous the measurement object may be, the higher the required speed for performing a reliable optical measurement may be. Thus, as an example, the predetermined threshold may be predetermined by specifying the type of the measurement object before performing the optical measurement or at a beginning of the optical measurement. The predetermined threshold may be inclusive or exclusive. Thus, an event may already be triggered for a quantity being equal the predetermined threshold or only for the quantity being larger or smaller than the threshold, respectively. As an example, the predetermined threshold empirically by observing a measurement uncertainty of the portable spectrometer as a function of the movement sensor signal and by providing an admissible maximum measurement uncertainty. The predetermined threshold may be the movement sensor signal when the measurement uncertainty is equal to the admissible maximum measurement uncertainty. Other options for determining the predetermined threshold, however, are feasible.

The evaluation device may be configured for automatically determining the item of spectral measurement information on the measurement object only if the speed exceeds the predetermined threshold. The evaluation device may be configured for automatically determining the item of spectral measurement information on the measurement object only if the speed is equal to or larger than the predetermined threshold. The evaluation device may be configured for automatically determining the item of spectral measurement information on the measurement object only if the speed is larger than the predetermined threshold. The evaluation device may be configured for automatically discarding the photosensor signal if the speed is below the predetermined threshold. The evaluation device may be configured for automatically discarding the photosensor signal if the speed is equal to or below the predetermined threshold. Thus, untrustworthy and potentially misleading measurement data may automatically not be collected.

The evaluation device may be configured for recording a speed profile of at least one of the portable spectrometer and the measurement object over a measurement time of the optical measurement. The term “speed profile” as used herein is a broad term and is to be given its ordinary and customary meaning to a person of ordinary skill in the art and is not to be limited to a special or customized meaning. The term specifically may refer, without limitation, to a progress of the speed of an object over time. The speed profile may be usable for determining at least one position profile, wherein the position profile may comprise at least one position of the object over time. Analogously, term “position profile” as used herein is a broad term and is to be given its ordinary and customary meaning to a person of ordinary skill in the art and is not to be limited to a special or customized meaning. The term specifically may refer, without limitation, to progress of the position of an object over time. A position profile of the portable spectrometer and/or the measurement object may e.g. be determinable by integrating the speed of the portable spectrometer and/or the measurement object over time.

The item of measurement quality information on the optical measurement may comprise at least one of a position of the portable spectrometer, a position of the measurement object and a relative position of the portable spectrometer with respect to the measurement object. The term “position” as used herein is a broad term and is to be given its ordinary and customary meaning to a person of ordinary skill in the art and is not to be limited to a special or customized meaning.

The term specifically may refer, without limitation, to a spatial arrangement of an object, specifically within a reference system which may e.g. be representable as coordinate system, such as a Cartesian coordinate system or a polar coordinate system. The position may comprise at least one coordinate of the object or more specifically of at least one point of the object, e.g. of a center of mass of the object. However, other points, e.g. edges, may also be feasible. The position may comprise an orientation of the object, such as an orientation after a rotation of the object. The position, more specifically a spatial shift in the position, may refer to a deformation of the object or may be caused by a deformation of the object. Additionally or alternatively, the shift in the position may refer to a translation and/or to a rotation of the object or may be caused by a translation and/or a rotation of the object.

The evaluation device may be configured for automatically determining the item of spectral measurement information on the measurement object only after a spatial shift in the position of at least 10 cm, specifically of at least 5 cm, more specifically of at least 1 cm, during integration time, specifically during integration time of the photosensor of the portable spectrometer. The integration time may refer to a time interval during which the photosensor, specifically the photosensitive region of the photosensor, receives the optical radiation. The photosensor signal generated by the photosensor may be indicative of the amount of optical radiation received by the photosensor, specifically by the photosensitive region, during the integration time. As an example, the integration time may be in the range of 0.1 to 10 s, preferably 1 s. However, shorter and/or longer integration times are also feasible. Further, the spatial shift to be moved may be a function of a coarseness and/or an intrinsic inhomogeneity of the measurement object. Thus, the optical measurement may be stopped once a part of the measurement object has been measured and may only be restarted as soon as the portable spectrometer is moved to a different part of the measurement object. In such way, it may be ensured that the measurement object is measured in sufficiently distant or remote places of the measurement object. Further, positional information may generally help finding a reason for optical measurements having low accuracy, e.g. a weak spectrum or an unexpected spectrum. Typical problems may be that the optical measurement was performed beyond the limits of the measurement object, so that only a sample holder or air may be measured, or that the portable spectrometer was tilted or moved away from the measurement object. When finding out the reason, it may be prompted to the user who can repeat the optical measurement and focus on this problem to achieve a better result.

The evaluation device may be configured for determining at least one surface plane of the measurement object by using the position. The term “surface plane” as used herein is a broad term and is to be given its ordinary and customary meaning to a person of ordinary skill in the art and is not to be limited to a special or customized meaning. The term specifically may refer, without limitation, to a plane which, at least in good approximation and/or at least partially, models or maps the surface of an object, specifically of the measurement object. As already indicated, the measurement object may comprise an arbitrary shape. The measurement object may specifically comprise an arbitrary surface roughness. However, the measurement object may typically, at least within a restricted area being subject to investigation, be essentially flat or spherical. As an example, the measurement object may, at least in good approximation neglecting surface roughness, be a cuboid or a sphere. Thus, it may typically be possible to model the surface of the measurement object by using one or more surface planes. The evaluation device may be configured for automatically determining the item of spectral measurement information on the measurement object only if the portable spectrometer is tilted less than 30° relative to a normal of the surface plane of the measurement object, specifically less than 20° relative to a normal of the surface plane of the measurement object, more specifically less than 10° relative to a normal of the surface plane of the measurement object. Additionally or alternatively, the evaluation device may be configured for automatically determining the item of spectral measurement information on the measurement object only if the portable spectrometer is moved away from the surface plane of the measurement object by no more than 10 cm, specifically by no more than 5 cm, more specifically by no more than 1 cm. For example, the evaluation device may be configured for determining the item of spectral measurement information only if the portable spectrometer does not leave the surface plane of the measurement object, specifically such that the portable spectrometer does not move away from the surface plane by more than the given distance and creates an air gap between the portable spectrometer and the measurement object. Preferably, the portable spectrometer and the measurement object may be in contact with each other for determining the item of spectral measurement information. In such way, it may be ensured that the portable spectrometer is not tilted to far against a normal of a surface plane of the measurement object and/or moves too far away from the measurement object when performing the optical measurement, which may typically decrease accuracy and/or signal strength of the optical measurement.

The evaluation device may be configured for determining at least one item of user feedback by using the item of measurement quality information on the optical measurement, wherein the portable spectrometer further comprises at least one user interface configured for indicating the item of user feedback to a user of the portable spectrometer. The item of user feedback may indicate at least one of the following to the user of the portable spectrometer: an expected accuracy of the optical measurement, a speed of the portable spectrometer, a speed of the measurement object, a relative speed of the portable spectrometer with respect to the measurement object, a position of the portable spectrometer, a position of the measurement object, a relative position of the portable spectrometer with respect to the measurement object. The term “item of user feedback” as used herein is a broad term and is to be given its ordinary and customary meaning to a person of ordinary skill in the art and is not to be limited to a special or customized meaning. The term specifically may refer, without limitation, to an item of information, specifically on at least one aspect of the optical measurement, configured for being presented or indicated, in an in principle arbitrary fashion, to at least one user, specifically a user of the portable spectrometer. In other words, the item of user feedback may be configured for informing the user about at least one aspect, e.g. on at least one measurement parameter, of the optical measurement. Several examples were given above and further options may also be feasible. The item of user feedback may be at least one of visual, acoustic and haptic. Other options may also be feasible. As an example, the item of user feedback may be a visual representation, e.g. of a speed of the portable spectrometer, such as a written number or word or sentence, e.g. on a display of the portable spectrometer.

The term “interface” as used herein is a broad term and is to be given its ordinary and customary meaning to a person of ordinary skill in the art and is not to be limited to a special or customized meaning. The term specifically may refer, without limitation, to a device configured for unidirectionally or bidirectionally exchanging at least one item of information, such as for exchange of one or more of data or commands, between at least to entities, e.g. two devices or a device and a user. The interface may comprise at least one of an output device configured for transmitting information and an input device configured for receiving information. The interface may be wireless and/or wire-bound. The interface may be or comprise at least one web interface. The interface may be configured for providing at least one data transfer connection, e.g. Bluetooth or NFC. The interface may be or may comprise at least one port comprising one or more of a network or internet port and a USB-port. The term “user interface” as used herein is a broad term and is to be given its ordinary and customary meaning to a person of ordinary skill in the art and is not to be limited to a special or customized meaning. The term specifically may refer, without limitation, to an interface configured for interacting with a user, specifically a user of the portable spectrometer. The user interface may be configured for unidirectionally or bidirectionally exchanging at least one item of information between the portable spectrometer and the user, specifically at least one item of information on the optical measurement. The user interface may be configured for sharing at least one item of information with a user and/or for receiving at least one item of information by the user. The user interface may comprise at least one of a display, specifically a touch-display, a loudspeaker, a microphone and a vibrator. Other options may also be feasible. As an example, the user interface may comprise a touch-display configured for displaying at least one item of information on the optical measurement to the user and/or for receiving at least one command by the user, e.g. regarding a continuation or a cancellation of the optical measurement, such as via a touch input. For example, the portable spectrometer may be connected to or comprised by an electronic communication device, such as a smartphone or a tablet, wherein the user interface of the portable spectrometer is a touch-display of the electronic communication device.

The item of user feedback may comprise at least one action proposal to the user of the portable spectrometer, specifically an action proposal for moving the portable spectrometer faster or to another position. The term “action proposal” as used herein is a broad term and is to be given its ordinary and customary meaning to a person of ordinary skill in the art and is not to be limited to a special or customized meaning. The term specifically may refer, without limitation, to a suggestion or request or proposal, specifically to a user of the portable spectrometer, for taking at least one measure or action, specifically with regard to the optical measurement. As indicated, the action proposal may invite or ask the user to adapt at least one measurement parameter the optical measurement, e.g. a speed of the portable spectrometer, specifically for achieving a better accuracy of the optical measurement. As an example, the user may move the portable spectrometer too slow and a faster speed may be more suitable due to a high inhomogeneity of the measurement object.

The item of user feedback may comprise at least one query to the user of the portable spectrometer, specifically a query whether the optical measurement is to be used or to be discarded. The term “query” as used herein is a broad term and is to be given its ordinary and customary meaning to a person of ordinary skill in the art and is not to be limited to a special or customized meaning. The term specifically may refer, without limitation, to at least one of an inquiry to a user, a request to a user and an information retrieval from a user. The query may comprise at least one option available to the user. Specifically, the query may comprise at least two options the user can choose from. The query may be a binary query, such as a yes-or-no query. The query may comprise presenting at least one available option to the user and receiving an input regarding at least one selected option from the user.

The photosensor may be configured for detecting optical radiation in a wavelength of 300 nm to 3000 nm, specifically 500 nm to 2500 nm, more specifically 1400 nm to 2000 nm. The photosensitive region may comprise at least one photoconductive material. The photoconductive material may be selected from at least one of PbS, PbSe, Ge, InGaAs, InSb, Si and HgCdTe. Other options, such as photodiodes or thermopiles, may also be feasible.

The photosensor may comprise at least one readout device configured for reading out the photosensitive region. The term “readout device” as used herein is a broad term and is to be given its ordinary and customary meaning to a person of ordinary skill in the art and is not to be limited to a special or customized meaning. The term specifically may refer, without limitation, to an electronic circuit configured for quantifying and/or processing at least one physical quantity and/or a change in at least one physical quantity detected by at least one measurement device, such as the photosensitive region of the photosensor of the portable spectrometer. The readout device may comprise at least one of a current divider, a voltage divider, a current meter, a voltage meter, a resistance meter and an analog-to-digital converter. Further options may be feasible.

The portable spectrometer may further comprise at least one radiation source configured for emitting optical radiation at least partially towards the measurement object. The term “radiation source” as used herein is a broad term and is to be given its ordinary and customary meaning to a person of ordinary skill in the art and is not to be limited to a special or customized meaning.

The term specifically may refer, without limitation, to a device configured for emitting optical radiation. The radiation source may be configured for emitting optical radiation towards the measurement object, such as in form of a light beam. The radiation source may be configured for isotopically emitting optical radiation, e.g. uniformly in all spatial directions, wherein only a part of the emitted optical radiation may impinge the measurement object. The radiation source may comprise at least one of a semiconductor-based radiation source, specifically at least one of a light emitting diode and a laser, and a thermal radiator, specifically an incandescent lamp. The radiation source may be modulated, e.g. by using an optical chopper. Further options may be feasible.

The evaluation device may be configured for controlling at least one of the photosensor, the movement sensor and optionally the radiation source. The evaluation device may be configure for controlling the portable spectrometer or at least one part of the portable spectrometer. The evaluation device may be at least partially cloud-based. The term “cloud-based” as used herein is a broad term and is to be given its ordinary and customary meaning to a person of ordinary skill in the art and is not to be limited to a special or customized meaning. The term specifically may refer, without limitation, to an outsourcing of the evaluation device or of at least one part of the evaluation device to at least partially interconnected external devices, specifically computers or computer networks having larger computing power and/or data storage volume. The external devices may be arbitrarily spatially distributed. The external devices may vary over time, specifically on demand. The external devices may be interconnected by using the internet and/or at least one intranet. The external devices may each comprise at least one interface, such as a communication interface for transferring data. As already indicated, the evaluation device may comprise at least one interface, such as a communication interface for transferring data.

In a further aspect of the present invention, a method for performing at least one optical measurement on at least one measurement object by using at least one portable spectrometer according to any one embodiments described above or below in further detail referring to a portable spectrometer is disclosed. The method comprises the following steps:
a) performing a movement of at least one of the portable spectrometer and the measurement object;
b) generating at least one movement sensor signal dependent on the movement by using the movement sensor of the portable spectrometer;
c) determining at least one item of measurement quality information on the optical measurement from the movement sensor signal by using the evaluation device of the portable spectrometer;
d) generating at least one photosensor signal dependent on an illumination of the photosensitive region by using the photosensor of the portable spectrometer; and
e) determining at least on item of spectral information on the measurement object from the photosensor signal by using the evaluation device.

The method steps may be performed in the indicated order. It shall be noted, however, that a different order is also possible. The method may comprise further method steps which are not listed. Further, one or more of the method steps may be performed once or repeatedly. Further, two or more of the method steps may be performed simultaneously or in a timely overlapping fashion.

Step c) may further comprise automatically using the item of measurement quality information on the optical measurement as a trigger for determining the item of spectral measurement information on the measurement object, specifically by automatically triggering the optical measurement if the item of measurement quality information indicates that at least one predetermined measurement condition for an accurate optical measurement on the measurement object is fulfilled. Step c) may further comprise determining at least one item of user feedback to a user of the portable spectrometer by using the item of measurement quality information on the optical measurement. Step c) may further comprise proposing at least one user action, specifically moving the portable spectrometer faster or moving the portable spectrometer to another position before carrying out step d). Step c) may further comprise performing at least one user query, specifically whether the optical measurement is to be carried on with step d) or whether the optical measurement is to be aborted. For further definitions and embodiments regarding the method for performing at least one optical measurement on at least one measurement object, reference may also be made to the description above.

The method may at least partially be computer-implemented. Thus, at least one method step may at least partially be computer-implemented. Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

In a further aspect of the present invention, a non-transient computer-readable medium is disclosed. The non-transient computer-readable medium includes instructions that, when executed by one or more processors, cause the one or more processors to perform the method according to any one of the embodiments described above or below in further detail referring to a method.

In a further aspect of the present invention, a non-transient computer-readable medium is disclosed, including instructions that, when executed by one or more portable spectrometer according to the present invention, such as according to any one of the embodiments described above and/or according to any one of the embodiments disclosed in further detail below, cause the one or more portable spectrometer to perform at least one of the methods according to the present invention, such as according to any one of the embodiments described above and/or according to any one of the embodiments disclosed in further detail below.

In a further aspect of the present invention, a use of a portable spectrometer according to any one of the embodiments described above or below in further detail referring to a portable spectrometer is disclosed for a purpose of use, selected from the group consisting of: an infrared detection application; a heat detection application; a thermometer application; a heat-seeking application; a flame-detection application; a fire-detection application; a smoke-detection application; a temperature sensing application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application; a cosmetic application.

The devices and methods as disclosed herein have considerable advantages over the prior art. A measurement object, specifically an inhomogeneous measurement object, may have to be measured in different locations in order to obtain a representative spectrum of the entire measurement object. This may typically increase the demands on users, specifically non-expert users. If the measurement object is not measured at sufficiently distant positions, e.g. due to a too low moving speed during the measurement, this may yield less accurate measurement results. This can however be avoided by the devices and methods disclosed herein. The portable spectrometer of the present invention, also simply due to being portable, specifically facilitates use by non-expert users. Further, specifically by using a movement sensor, the portable spectrometer can track the movement of itself and/or of the measurement object and based on this evaluate an accuracy of the optical measurement. Thereupon, the portable spectrometer can automatically decide whether to use the optical measurement or not, such that no unnecessary and potentially misleading measurement results are collected and presented to the user. Additionally or alternatively, the portable spectrometer can interact with the user, e.g. by indicating an accuracy of the optical measurement, and ask the user about a further procedure. The portable spectrometer may even further assist the user during the optical measurement by giving instruction for improving accuracy of the optical measurements, e.g. for moving the portable spectrometer faster or to another position. In such way, the devices and methods as disclosed herein may facilitate increasing accuracy of optical measurements, specifically by obtaining a sufficiently representative spectrum of an entire measurement object, specifically for use by non-expert users.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Summarizing and without excluding further possible embodiments, the following embodiments may be envisaged:

Embodiment 1: A portable spectrometer for performing at least one optical measurement on at least one measurement object, the portable spectrometer comprising:
at least one optical element configured for separating incident optical radiation provided by the measurement object into a spectrum of constituent wavelength components;
at least one photosensor comprising at least one photosensitive region configured for receiving the optical radiation from the optical element, wherein the photosensor is configured for generating at least one photosensor signal dependent on an illumination of the photosensitive region by the optical radiation;
at least one movement sensor configured for generating at least one movement sensor signal dependent on a movement of at least one of the portable spectrometer and the measurement object; and
at least one evaluation device configured for determining at least one item of measurement quality information on the optical measurement by using the movement sensor signal, wherein the evaluation device is further configured for determining at least one item of spectral measurement information on the measurement object by using the photosensor signal.

Embodiment 2: The portable spectrometer according to the preceding embodiment, wherein the movement sensor signal is dependent on at least one of an absolute movement of the portable spectrometer, specifically a speed of the portable spectrometer; an absolute movement of the measurement object, specifically a speed of the measurement object; a relative movement of the portable spectrometer with respect to the measurement object or vice versa, specifically a relative speed.

Embodiment 3: The portable spectrometer according to any one of the preceding embodiments, wherein the item of measurement quality information on the optical measurement comprises information indicating whether at least one predetermined measurement condition for an accurate optical measurement on the measurement object is fulfilled, specifically at least one measurement condition regarding at least one of: the movement of at least one of the portable spectrometer and the measurement object; a position of at least one of the portable spectrometer and the measurement object.

Embodiment 4: The portable spectrometer according to any one of the preceding embodiments, wherein the item of measurement quality information on the optical measurement comprises an expected accuracy of the optical measurement, the expected accuracy being derived by using the movement sensor signal.

Embodiment 5: The portable spectrometer according to any one of the preceding embodiments, wherein the evaluation device is configured for automatically using the item of measurement quality information on the optical measurement as a trigger for determining the item of spectral measurement information on the measurement object, specifically by automatically triggering the determining of the item of spectral measurement information on the measurement object if the item of measurement quality information indicates that at least one predetermined measurement condition for an accurate optical measurement on the measurement object is fulfilled.

Embodiment 6: The portable spectrometer according to any one of the preceding embodiments, wherein the item of measurement quality information on the optical measurement comprises at least one of a speed of the portable spectrometer, a speed of the measurement object and a relative speed of the portable spectrometer with respect to the measurement object.

Embodiment 7: The portable spectrometer according to the preceding embodiment, wherein the item of measurement quality information on the optical measurement indicates whether the speed exceeds a predetermined threshold.

Embodiment 8: The portable spectrometer according to the preceding embodiment, wherein the evaluation device is configured for automatically determining the item of spectral measurement information on the measurement object only if the speed exceeds the predetermined threshold.

Embodiment 9: The portable spectrometer according to any one of the two preceding embodiments, wherein the evaluation device is configured for automatically discarding the photosensor signal if the speed is below the predetermined threshold.

Embodiment 10: The portable spectrometer according to any one of the preceding embodiments, wherein the movement sensor comprises at least one of an acceleration sensor, a speed gauge, a position sensor, a gyroscope, an optical sensor, specifically an optical speed sensor.

Embodiment 11: The portable spectrometer according to any one of the preceding embodiments, wherein the evaluation device is configured for recording a speed profile of at least one of the portable spectrometer and the measurement object over a measurement time of the optical measurement.

Embodiment 12: The portable spectrometer according to any one of the preceding embodiments, wherein the item of measurement quality information on the optical measurement comprises at least one of a position of the portable spectrometer, a position of the measurement object and a relative position of the portable spectrometer with respect to the measurement object.

Embodiment 13: The portable spectrometer according to the preceding embodiment, wherein the evaluation device is configured for automatically determining the item of spectral measurement information on the measurement object only after a spatial shift in the position of at least 10 cm, specifically of at least 5 cm, more specifically of at least 1 cm, during integration time.

Embodiment 14: The portable spectrometer according to any one of the two preceding embodiments, wherein the evaluation device is configured for determining at least one surface plane of the measurement object by using the position.

Embodiment 15: The portable spectrometer according to the preceding embodiment, wherein the evaluation device is configured for automatically determining the item of spectral measurement information on the measurement object only if the portable spectrometer is tilted less than 30° relative to a normal of the surface plane of the measurement object, specifically less than 20° relative to a normal of the surface plane of the measurement object, more specifically less than 10° relative to a normal of the surface plane of the measurement object.

Embodiment 16: The portable spectrometer according to any one of the two preceding claims, wherein evaluation device is configured for automatically determining the item of spectral measurement information on the measurement object only if the portable spectrometer is moved away from the surface plane of the measurement object by no more than 10 cm, specifically by no more than 5 cm, more specifically by no more than 1 cm.

Embodiment 17: The portable spectrometer according to any one of the preceding embodiments, wherein the evaluation device is configured for determining at least one item of user feedback by using the item of measurement quality information on the optical measurement, wherein the portable spectrometer further comprises at least one user interface configured for indicating the item of user feedback to a user of the portable spectrometer.

Embodiment 18: The portable spectrometer according to the preceding embodiment, wherein the item of user feedback indicates at least one of the following to the user of the portable spectrometer: an expected accuracy of the optical measurement, a speed of the portable spectrometer, a speed of the measurement object, a relative speed of the portable spectrometer with respect to the measurement object, a position of the portable spectrometer, a position of the measurement object, a relative position of the portable spectrometer with respect to the measurement object.

Embodiment 19: The portable spectrometer according to any one of two the preceding embodiments, wherein the item of user feedback comprises at least one action proposal to the user of the portable spectrometer, specifically an action proposal for moving the portable spectrometer faster or to another position.

Embodiment 20: The portable spectrometer according to any one of three the preceding embodiments, wherein the item of user feedback comprises at least one query to the user of the portable spectrometer, specifically a query whether the optical measurement is to be used or to be discarded.

Embodiment 21: The portable spectrometer according to any one of the preceding embodiments, wherein the photosensor is configured for detecting optical radiation in a wavelength of 300 nm to 3000 nm, specifically 500 nm to 2500 nm, more specifically 1400 nm to 2000 nm.

Embodiment 22: The portable spectrometer according to any one of the preceding embodiments, wherein the photosensitive region comprises at least one photoconductive material.

Embodiment 23: The portable spectrometer according to the preceding embodiment, wherein the photoconductive material is selected from at least one of PbS, PbSe, Ge, InGaAs, InSb, Si and HgCdTe.

Embodiment 24: The portable spectrometer according to any one of the preceding embodiments, wherein the photosensor comprises at least one readout device configured for reading out the photosensitive region.

Embodiment 25: The portable spectrometer according to any one of the preceding embodiments, further comprising at least one radiation source configured for emitting optical radiation at least partially towards the measurement object.

Embodiment 26: The portable spectrometer according to the preceding embodiment, wherein the radiation source comprises at least one of a semiconductor-based radiation source, specifically at least one of a light emitting diode and a laser, and a thermal radiator, specifically an incandescent lamp.

Embodiment 27: The portable spectrometer according to any one of the preceding embodiments, wherein the evaluation device is configured for controlling at least one of the photosensor, the movement sensor and optionally the radiation source.

Embodiment 28: The portable spectrometer according to any one of the preceding embodiments, wherein the evaluation device is at least partially cloud-based.

Embodiment 29: The portable spectrometer according to any one of the preceding embodiments, wherein the optical element comprises at least one optical filter element.

Embodiment 30: A method method for performing at least one optical measurement on at least one measurement object by using at least one portable spectrometer according to any one of the preceding embodiments, the method comprising the following steps:
a) performing a movement of at least one of the portable spectrometer and the measurement object;
b) generating at least one movement sensor signal dependent on the movement by using the movement sensor of the portable spectrometer;
c) determining at least one item of measurement quality information on the optical measurement from the movement sensor signal by using the evaluation device of the portable spectrometer;
d) generating at least one photosensor signal dependent on an illumination of the photosensitive region by using the photosensor of the portable spectrometer; and
e) determining at least on item of spectral information on the measurement object from the photosensor signal by using the evaluation device.

Embodiment 31: The method according to the preceding embodiment, wherein step c) further comprises automatically using the item of measurement quality information on the optical measurement as a trigger for determining the item of spectral measurement information on the measurement object, specifically by automatically triggering the optical measurement if the item of measurement quality information indicates that at least one predetermined measurement condition for an accurate optical measurement on the measurement object is fulfilled.

Embodiment 32: The method according to any one of the preceding method embodiments, wherein step c) further comprises determining at least one item of user feedback to a user of the portable spectrometer by using the item of measurement quality information on the optical measurement.

Embodiment 33: The method according to the preceding embodiment, wherein step c) further comprises proposing at least one user action, specifically moving the portable spectrometer faster or moving the portable spectrometer to another position before carrying out step d).

Embodiment 34: The method according to any one of two the preceding embodiments, wherein step c) further comprises performing at least one user query, specifically whether the optical measurement is to be carried on with step d) or whether the optical measurement is to be aborted.

Embodiment 35: The method according to any one of the preceding method embodiments, wherein the method is at least partially computer-implemented.

Embodiment 36: A non-transient computer-readable medium including instructions that, when executed by one or more processors, cause the one or more processors to perform at least one of the methods according to any one of the preceding method embodiments.

Embodiment 37: A non-transient computer-readable medium including instructions that, when executed by one or more portable spectrometer according to any one of the preceding embodiments referring to a portable spectrometer, cause the one or more portable spectrometer to perform at least one of the methods according to any one of the preceding method embodiments.

Embodiment 38: A use of a portable spectrometer according to any one of the preceding embodiments referring to a portable spectrometer for a purpose of use, selected from the group consisting of: an infrared detection application; a heat detection application; a thermometer application; a heat-seeking application; a flame-detection application; a fire-detection application; a smoke-detection application; a temperature sensing application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application; a cosmetic application.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 schematically shows an exemplary embodiment of a portable spectrometer;

FIGS. 2A-2B schematically show examples of a user interaction of the portable spectrometer with a user; and

FIG. 3A-3C show flow charts of exemplary embodiments of a method for performing at least one optical measurement on at least one measurement object by using the portable spectrometer.

### DETAILED DESCRIPTION OF THE EMBODIMENTS

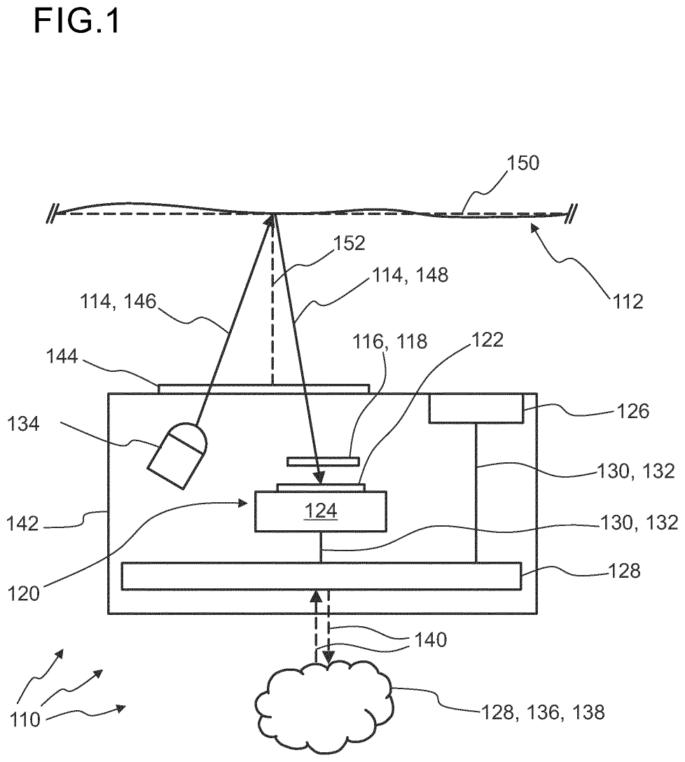

FIG. 1 schematically shows an exemplary embodiment of a portable spectrometer 110. The portable spectrometer 110 is configured for performing at least one optical measurement on at least one measurement object 112. The measurement object 112 may have an arbitrary shape and/or composition. The measurement object 112 may be a solid and/or fluid sample. The measurement object 112 may comprise at least one surface having an arbitrary surface roughness. The measurement object 112 may be configured for providing optical radiation 114, such as for at least one of emitting, transmitting and reflecting, e.g. diffusely reflecting, the optical radiation 114. The optical radiation 114 provided by the measurement object 112 may comprise a wavelength of 300 nm to 3000 nm, specifically of 500 nm to 2500 nm, more specifically of 1400nm to 2000 nm. Thus, the optical radiation 114 provided by the measurement object 112 may, specifically, be IR radiation, more specifically NIR radiation.

The portable spectrometer 110 comprises at least one optical element 116 configured for separating incident optical radiation 114 provided by the measurement object 112 into a spectrum of constituent wavelength components. The optical element 116 may comprise at least one optical filter element 118. The optical filter element 118 may be configured for filtering the optical radiation 114 or more specifically at least one selected spectral range of the optical radiation 114. The optical filter element 118 may specifically be positioned in a beam path before a photosensor 120 of the portable spectrometer 110.

The portable spectrometer 110 comprises at least one photosensor 120. The photosensor 120 comprises at least one photosensitive region 122 configured for receiving the optical radiation 114 from the optical element 116. The photosensor 120 is configured for generating at least one photosensor signal dependent on an illumination of the photosensitive region 122 by the optical radiation 114. The photosensor 120 may be configured for detecting the optical radiation 114 in a wavelength of 300 nm to 3000 nm, specifically 500 nm to 2500 nm, more specifically 1400 nm to 2000 nm. The photosensitive region 122 may comprise at least one photoconductive material. The photoconductive material may be selected from at least one of PbS, PbSe, Ge, InGaAs, InSb, and HgCdTe. The photosensor 120 may further comprise at least one readout device 124 configured for reading out the photosensitive region 122, e.g. for measuring a photocurrent and/or for generating a digital count.

The portable spectrometer 110 comprises at least one movement sensor 126 configured for generating at least one movement sensor signal dependent on a movement of at least one of the portable spectrometer 110 and the measurement object 112. The movement sensor 126 may comprise at least one of an acceleration sensor, a speed gauge, a position sensor, a gyroscope, an optical sensor, specifically an optical speed sensor. The movement sensor signal may be dependent on at least one of an absolute movement of the portable spectrometer 110, specifically a speed of the portable spectrometer 110; an absolute movement of the measurement object 112, specifically a speed of the measurement object 112; a relative movement of the portable spectrometer 110 with respect to the measurement object 112 or vice versa, specifically a relative speed.

The portable spectrometer 110 comprises at least one evaluation device 128 configured for determining at least one item of measurement quality information on the optical measurement by using the movement sensor signal. The evaluation device 128 is further configured for determining at least one item of spectral measurement information on the measurement object 112 by using the photosensor signal. The evaluation device 128 may be connected to at least one of the photosensor 120 and the movement sensor 126, such as by using at least one of a wire 130 and a trace 132. The portable spectrometer 110 may further comprise at least one radiation source 134 configured for emitting the optical radiation 114 at least partially towards the measurement object 112. The radiation source 134 may comprise at least one of a semiconductor based radiation source, specifically at least one of a light emitting diode and a laser, and a thermal radiator, specifically an incandescent lamp. The evaluation device 128 may be configured for controlling at least one of the photosensor 120, the movement sensor 126 and the radiation source 134.

The evaluation device 128 may at least partially be cloud-based. In other words, the evaluation device 128 may at least partially be distributed in at least one cloud 136 configured for being used for at least one of cloud computing and cloud storage. The cloud 136 may specifically comprise at least one external device 138, such as a computer or a computer network. The external device 138 may specifically comprise more data storage volume and/or more computing power, e.g. for further processing and/or evaluating the photosensor signal and/or the movement sensor signal. The cloud 136, specifically at least one of the evaluation device 128 and the external device 138, may comprise at least one communication interface 140 configured for transferring data. The different parts of the cloud 136, specifically the evaluation device 128 and the external device 138, may at least partially be interconnected by the communication interface 140. The communication interface 140 may be at least one of wireless and wire-bound.

As said, the portable spectrometer 110 is only schematically shown in FIG. 1, specifically for giving an expedient overview of the various indicated components of the portable spectrometer 110. Notwithstanding this, the portable spectrometer 110 may specifically be configured for being moved, specifically carried, by at least one user, specifically by only one user. More specifically, the portable spectrometer 110 may be configured, specifically by at least one of a size of the portable spectrometer 110 and a weight of the portable spectrometer 110, for being carried by only one user in his or her hand. Specifically, the portable spectrometer 110 may be or may be a part of a mobile device or a wearable device. As an example, the portable spectrometer 110 may be a part of a smartphone, a tablet or a smartwatch. The spectrometer 110 may comprise at least one housing 142 surrounding at least parts of the portable spectrometer 110. Specifically, the external device 138 of the cloud 136 may be arranged outside of the housing 142. The housing 142 may be configured for being moved, specifically carried, by at least one user, specifically by only one user. More specifically, the housing 142 may be configured for being carried by only one user in his or her hand. The housing 142 may comprise at least one window 144. The window 144 may at least partially be transparent for the optical radiation 114.

In the following, an exemplary operation principle of the portable spectrometer 110 is described with respect to FIG. 1. The radiation source 134 may emit the optical radiation 114 as emitted optical radiation 146 through the window 144 towards the measurement object 112. The measurement object 112 may at least partially, specifically diffusely, reflect the emitted optical radiation 146 towards the photosensitive region 122 of the photosensor 120 as reflected optical radiation 148. Further, the measurement object 112 may at least partially absorb the emitted optical radiation 146, which may be indicative of at least one physical property or chemical composition of the measurement object 112. The reflected optical radiation 148 may pass the window 144 and the optical filter element 118 before reaching the photosensitive region 122. The photosensitive region 122 may generate a corresponding photosignal which may be read out by using the readout device 124. In such way, the photosensor 120 may generate a photosensor signal and subsequently transmit it to the evaluation device 128 for further processing and/or evaluation. In parallel or offset in time, the movement sensor 126 may detect a movement of at least one of the portable spectrometer 110 and the measurement object 112, generate a corresponding movement sensor signal and also transmit it to the evaluation device 128. The evaluation device 128 may then determine a corresponding item of spectral measurement information and a corresponding item of measurement quality information, respectively.

The item of measurement quality information on the optical measurement may comprise information indicating whether at least one predetermined measurement condition for an accurate optical measurement on the measurement object is fulfilled, specifically at least one measurement condition regarding at least one of: the movement of at least one of the portable spectrometer 110 and the measurement object 112; a position of at least one of the portable spectrometer 110 and the measurement object 112. The item of measurement quality information on the optical measurement may comprise an expected accuracy of the optical measurement. The expected accuracy may be derived by using the movement sensor signal. An example of determining and assessing the expected accuracy is given in the description above, whereby reference may be made to this example in the description. The evaluation device 128 may be configured for automatically using the item of measurement quality information on the optical measurement as a trigger for determining the item of spectral measurement information on the measurement object 112, specifically by automatically triggering the determining of the item of spectral measurement information on the measurement object 112 if the item of measurement quality information indicates that at least one predetermined measurement condition for an accurate optical measurement on the measurement object 112 is fulfilled.

The item of measurement quality information on the optical measurement may comprise at least one of a speed of the portable spectrometer 110, a speed of the measurement object 112 and a relative speed of the portable spectrometer 110 with respect to the measurement object 112. The item of measurement quality information on the optical measurement may indicate whether the speed exceeds a predetermined threshold. The evaluation device 128 may be configured for automatically determining the item of spectral measurement information on the measurement object 112 only if the speed exceeds the predetermined threshold. The evaluation device 128 may be configured for automatically discarding the photosensor signal if the speed is below the predetermined threshold.

The evaluation device 128 may be configured for recording a speed profile of at least one of the portable spectrometer 110 and the measurement object 112 over a measurement time of the optical measurement. By evaluating the speed profile, specifically via integration over time, position information may be derived. The item of measurement quality information on the optical measurement may comprise at least one of a position of the portable spectrometer 110, a position of the measurement object 112 and a relative position of the portable spectrometer 110 with respect to the measurement object 112. The evaluation device 128 may be configured for automatically determining the item of spectral measurement information on the measurement object 112 only after a spatial shift in the position of at least 10 cm, specifically of at least 5 cm, more specifically of at least 1 cm, during integration time.

The evaluation device 128 may be configured for determining at least one surface plane 150 of the measurement object 112 by using the position. As already indicated, the measurement object 112 may comprise at least one surface having an arbitrary surface roughness. The surface plane 150 may indicate a fundamental orientation or a fundamental alignment of the surface of the measurement object 112. In the ideal case that the surface of the measurement object 112 is perfectly flat, the surface plane 150 may exactly match the surface of the measurement object 112 in every spatial point. Generally, the surface plane 150 may be determined by smoothening the surface of the measurement object 112 or by using standard statistical approaches, specifically averaging. The evaluation device 128 may be configured for automatically determining the item of spectral measurement information on the measurement object 112 only if the portable spectrometer 110 is tilted less than 30° relative to a normal 152 of the surface plane 150 of the measurement object 112, specifically less than 20° relative to the normal 152 of the surface plane 150 of the measurement object 112, more specifically less than 10° relative to the normal 152 of the surface plane 150 of the measurement object 112.

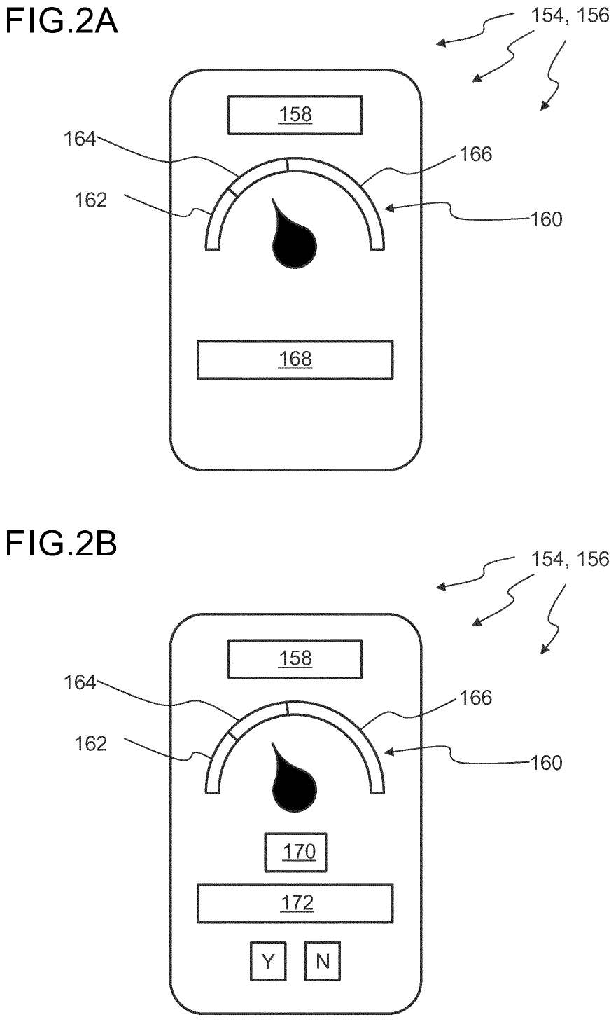

FIGS. 2A and 2B schematically show examples of a user interaction of the portable spectrometer 110 with a user of the portable spectrometer. The evaluation device 128 may be configured for determining at least one item of user feedback by using the item of measurement quality information on the optical measurement. The portable spectrometer 110 may further comprise at least one user interface 154 configured for indicating the item of user feedback to a user of the portable spectrometer 110. Specifically, the portable spectrometer 110 may comprise at least one display 156. The display 156 may specifically be arranged on at least one outer surface of the housing 142 of the portable spectrometer 110. Additionally or alternatively, the portable spectrometer 110 may be configured for transmitting the item of user feedback to the at least one external device 138, e.g. to at least one of a smart phone, a tablet and a smart watch, wherein the external device 138 may comprise the user interface 154, specifically the display 156.

The item of user feedback may indicate at least one of the following to the user of the portable spectrometer 110: an expected accuracy of the optical measurement, a speed of the portable spectrometer 110, a speed of the measurement object 112, a relative speed of the portable spectrometer 110 with respect to the measurement object 112, a position of the portable spectrometer 110, a position of the measurement object 112, a relative position of the portable spectrometer 110 with respect to the measurement object 112. As FIGS. 2A and 2B indicate, the display 156 may be configured for displaying the speed, e.g. of the portable spectrometer 110 while being moved relative to the measurement object 112 by the user. Thus, the display 156 may comprise at least one speed display 158. As FIGS. 2A and 2B further show, the display 156 may comprise a scale 160 indicating to a user whether the speed may be suitable for an accurate optical measurement or not. The scale 160 may be divided into three segments: a segment 162 indicating low suitability, a segment 164 indicating medium suitability, a segment 166 indicating high suitability. Specifically, segment 162 indicating low suitability and optionally also segment 164 indicating medium suitability may indicate to the user that the optical measurement should be discarded.

The item of user feedback may comprise at least one action proposal to the user of the portable spectrometer 110, specifically an action proposal for moving the portable spectrometer 110 faster or to another position. As FIG. 2A shows, the display 156 may comprise at least one action proposal display 168 configured for displaying the action proposal to the user of the portable spectrometer 110. As an example, the action proposal display 168 may display the text message “Move faster to trigger measurement” to the user. Thus, the optical measurement may automatically be discarded until the user moves the portable spectrometer 110 sufficiently fast.

The item of user feedback may comprise at least one query to the user of the portable spectrometer 110, specifically a query whether the optical measurement is to be used or to be discarded. As FIG. 2B shows, the display 156 may comprise at least one accuracy display 170 configured for displaying an expected accuracy of the optical measurement to the user of the portable spectrometer 110. As FIG. 2B further shows, the display 156 may comprise at least one query display 172 configured for displaying the query to the user. The display 156 may specifically be a touch display 174. Thus, the user may for instance input a response to the query via touching a specific area of the touch display. As an example, the query display 172 may display the text message “Start measurement?” and the user may touch selected areas of the touch display 174, e.g. marked by the letters Y or N, for responding with yes or no.

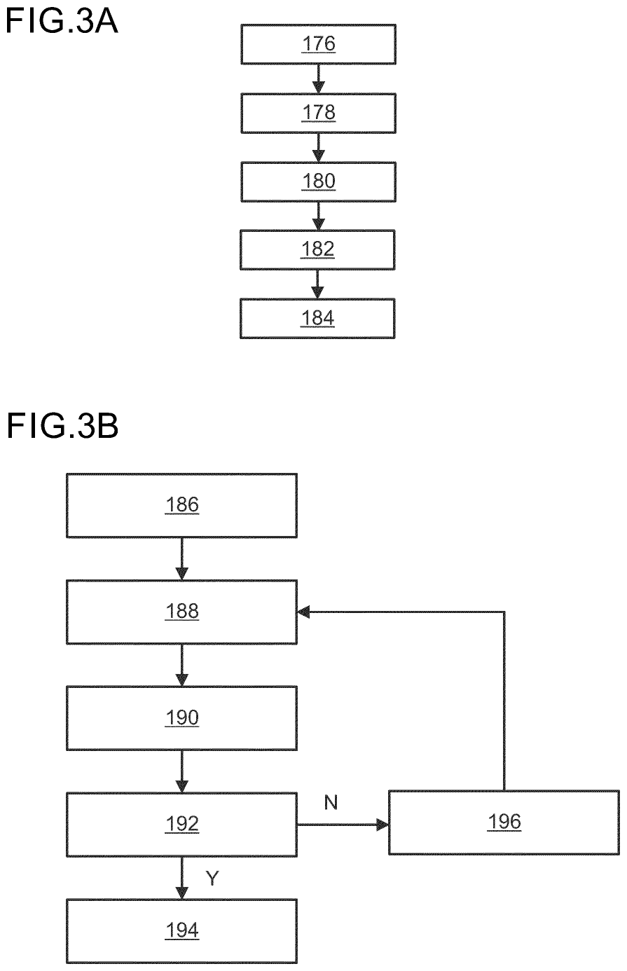

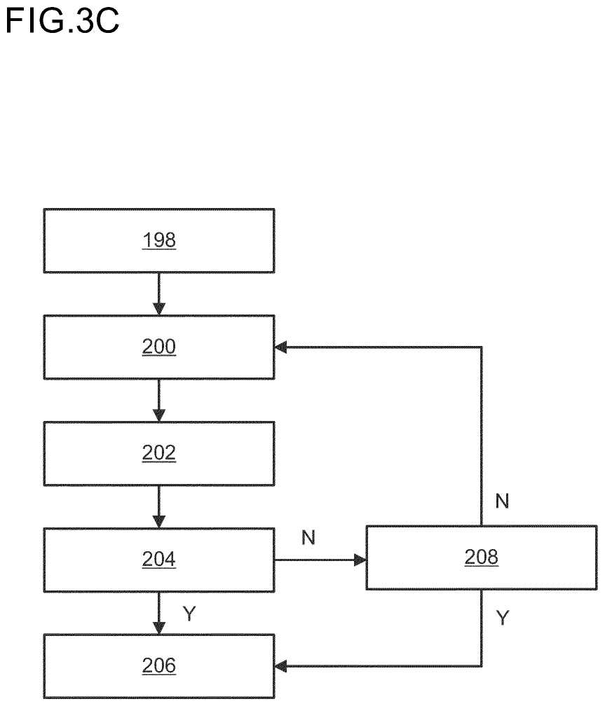

FIGS. 3A to 3C show flow charts of exemplary embodiments of a method for performing at least one optical measurement on the measurement object 112 by using the portable spectrometer 110 according to any one of the embodiments described above or below in further detail referring to the portable spectrometer 110. Specifically, FIG. 3A refers to a basic embodiment of the method comprising the following steps:
a) (denoted with reference number 176) performing a movement of at least one of the portable spectrometer 110 and the measurement object 112;
b) (denoted with reference number 178) generating at least one movement sensor signal dependent on the movement by using the movement sensor 126 of the portable spectrometer 110;
c) (denoted with reference number 180) determining at least one item of measurement quality information on the optical measurement from the movement sensor signal by using the evaluation device 128 of the portable spectrometer 110;
d) (denoted with reference number 182) generating at least one photosensor signal dependent on an illumination of the photosensitive region 122 by using the photosensor 120 of the portable spectrometer 110; and
e) (denoted with reference number 184) determining at least on item of spectral information on the measurement object 112 from the photosensor signal by using the evaluation device 128.

The method steps may be performed in the indicated order. It shall be noted, however, that a different order is also possible. The method may comprise further method steps which are not listed. Further, one or more of the method steps may be performed once or repeatedly. Further, two or more of the method steps may be performed simultaneously or in a timely overlapping fashion.

Step c) may further comprise automatically using the item of measurement quality information on the optical measurement as a trigger for determining the item of spectral measurement information on the measurement object 112, specifically by automatically triggering the optical measurement if the item of measurement quality information indicates that at least one predetermined measurement condition for an accurate optical measurement on the measurement object 112 is fulfilled. Step c) may further comprise determining at least one item of user feedback to a user of the portable spectrometer 110 by using the item of measurement quality information on the optical measurement. Step c) may further comprise proposing at least one user action, specifically moving the portable spectrometer 110 faster or moving the portable spectrometer 110 to another position before carrying out step d). Step c) may further comprise performing at least one user query, specifically whether the optical measurement is to be carried on with step d) or whether the optical measurement is to be aborted.

FIGS. 3B and 3C refer to specific possible embodiments of the method. FIG. 3B refers to a specific possible embodiment of the method which may comprise the following steps:
i) (denoted with reference number 186) sending a measurement request for performing an optical measurement;
ii) (denoted with reference number 188) generating at least one movement sensor signal dependent by using the movement sensor 126 of the portable spectrometer 110;
iii) (denoted with reference number 190) determining a speed of at least one of the portable spectrometer 110 and the measurement object 112 by using the movement sensor signal;
iv) (denoted with reference number 192) determining whether the speed exceeds a predetermined threshold;
v) (denoted with reference number 194) if the speeds exceeds the predetermined threshold, triggering the optical measurement; and
vi) (denoted with reference number 196) if the speed does not exceed the predetermined threshold, asking the user to move the portable spectrometer 110 faster and returning to step ii).

FIG. 3C refers to a specific possible embodiment of the method which may comprise the following steps:
A) (denoted with reference number 198) sending a measurement request for performing an optical measurement;
B) (denoted with reference number 200) generating at least one movement sensor signal dependent by using the movement sensor 126 of the portable spectrometer 110;
C) (denoted with reference number 202) determining a speed of at least one of the portable spectrometer 110 and the measurement object 112 by using the movement sensor signal;
D) (denoted with reference number 204) determining whether the speed exceeds a predetermined threshold;
E) (denoted with reference number 206) if the speeds exceeds the predetermined threshold, triggering the optical measurement; and
F) (denoted with reference number 208) if the speed does not exceed the predetermined threshold, asking the user if the optical measurement shall be performed anyway and, if the user indicates no, returning to step B) or, if the user indicates yes, continuing with step E).

The method may at least partially be computer-implemented. Thus, at least one method step may at least partially be computer-implemented. Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

### LIST OF REFERENCE NUMBERS

110 portable spectrometer
112 measurement object
114 optical radiation
116 optical element
118 optical filter element
120 photosensor
122 photosensitive region
124 readout device
126 movement sensor
128 evaluation device
130 wire
132 trace
134 radiation source
136 cloud
138 external device
140 communication interface
142 housing
144 window
146 emitted optical radiation
148 reflected optical radiation
150 surface plane
152 normal of the surface plane
154 user interface
156 display
158 speed display
160 scale
162 segment indicating low suitability
164 segment indicating medium suitability
166 segment indicating high suitability
168 action proposal display
170 accuracy display
172 query display
174 touch display
176 step a)
178 step b)
180 step c)
182 step d)
184 step e)
186 step i)
188 step ii)
190 step iii)
192 step iv)
194 step v)
196 step vi)
198 step A)
200 step B)
202 step C)
204 step D)
206 step E)
208 step F)

1. A portable spectrometer for performing at least one optical measurement on at least one measurement object, the portable spectrometer comprising:
at least one optical element configured for separating incident optical radiation provided by the measurement object into a spectrum of constituent wavelength components;
at least one photosensor comprising at least one photosensitive region configured for receiving the optical radiation from the optical element, wherein the photosensor is configured for generating at least one photosensor signal dependent on an illumination of the photosensitive region by the optical radiation;
at least one movement sensor configured for generating at least one movement sensor signal dependent on a movement of at least one of the portable spectrometer and the measurement object; and
at least one evaluation device configured for determining at least one item of measurement quality information on the optical measurement by using the movement sensor signal, wherein the evaluation device is further configured for determining at least one item of spectral measurement information on the measurement object by using the photosensor signal, wherein the item of measurement quality information on the optical measurement comprises at least one of a speed of the portable spectrometer, a speed of the measurement object and a relative speed of the portable spectrometer with respect to the measurement object, wherein the item of measurement quality information on the optical measurement indicates whether the speed exceeds a predetermined threshold, wherein the evaluation device is configured for automatically determining the item of spectral measurement information on the measurement object only if the speed exceeds the predetermined threshold.

2. The portable spectrometer according to claim 1, wherein the movement sensor signal is dependent on at least one of an absolute movement of the portable spectrometer; an absolute movement of the measurement object; and a relative movement of the portable spectrometer with respect to the measurement object or vice versa.

3. The portable spectrometer according to claim 1, wherein the item of measurement quality information on the optical measurement comprises information indicating whether at least one predetermined measurement condition for an accurate optical measurement on the measurement object is fulfilled.

4. The portable spectrometer according to claim 1, wherein the item of measurement quality information on the optical measurement comprises an expected accuracy of the optical measurement, the expected accuracy being derived by using the movement sensor signal.

5. The portable spectrometer according to claim 1, wherein the evaluation device is configured for automatically using the item of measurement quality information on the optical measurement as a trigger for determining the item of spectral measurement information on the measurement object.

6. The portable spectrometer according to claim 1, wherein the movement sensor comprises at least one of an acceleration sensor, a speed gauge, a position sensor, a gyroscope, and an optical sensor.

7. The portable spectrometer according to claim 1, wherein the item of measurement quality information on the optical measurement comprises at least one of a position of the portable spectrometer, a position of the measurement object and a relative position of the portable spectrometer with respect to the measurement object, wherein the evaluation device is configured for automatically determining the item of spectral measurement information on the measurement object only after a spatial shift in the position of at least 10 cm during integration time.

8. The portable spectrometer according to claim 7, wherein the evaluation device is configured for determining at least one surface plane of the measurement object by using the position, wherein the evaluation device is configured for automatically determining the item of spectral measurement information on the measurement object only if the portable spectrometer is tilted less than 30° relative to a normal of the surface plane of the measurement object and/or wherein evaluation device is configured for automatically determining the item of spectral measurement information on the measurement object only if the portable spectrometer is moved away from the surface plane of the measurement object by no more than 10 cm.

9. The portable spectrometer according to claim 1, wherein the evaluation device is configured for determining at least one item of user feedback by using the item of measurement quality information on the optical measurement, wherein the portable spectrometer further comprises at least one user interface configured for indicating the item of user feedback to a user of the portable spectrometer.

10. The portable spectrometer according to claim 2, wherein the item of user feedback indicates at least one of the following to the user of the portable spectrometer: an expected accuracy of the optical measurement, a speed of the portable spectrometer, a speed of the measurement object, a relative speed of the portable spectrometer with respect to the measurement object, a position of the portable spectrometer, a position of the measurement object, and a relative position of the portable spectrometer with respect to the measurement object.

11. A method for performing at least one optical measurement on at least one measurement object by using at least one portable spectrometer according to claim 1, the method comprising the following steps:
a) performing a movement of at least one of the portable spectrometer and the measurement object;
b) generating at least one movement sensor signal dependent on the movement by using the movement sensor of the portable spectrometer;
c) determining at least one item of measurement quality information on the optical measurement from the movement sensor signal by using the evaluation device of the portable spectrometer;
d) generating at least one photosensor signal dependent on an illumination of the photosensitive region by using the photosensor of the portable spectrometer; and
e) determining at least on item of spectral information on the measurement object from the photosensor signal by using the evaluation device.

12. A non-transient computer-readable medium including instructions that, when executed by one or more processors, cause the one or more processors to perform the method according to claim 11.

13. A method of using the portable spectrometer according to claim 1, the method comprising using the portable spectrometer for a purpose of use selected from the group consisting of an infrared detection application; a heat detection application; a thermometer application; a heat-seeking application; a flame-detection application; a fire-detection application; a smoke-detection application; a temperature sensing application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application; and a cosmetic application.
